(19) United States
(12) Patent Application Publication
(10) Pub. No.: US 2024/0385001 A1
(43) Pub. Date: Nov. 21, 2024

(54) PLANNING METHOD AND SYSTEM FOR PRIVATE VEHICLE CARBON FOOTPRINT VERIFICATION AND EMISSION REDUCTION

(71) Applicant: Pin-Huan CHOU, Taoyuan City (TW)

(72) Inventors: Pin-Huan CHOU, Taoyuan City (TW); Kai-Cheng CHUANG, Nantou County (TW)

(73) Assignee: Pin-Huan CHOU, Taoyuan City (TW)

(21) Appl. No.: 18/664,181

(22) Filed: May 14, 2024

Related U.S. Application Data
(60) Provisional application No. 63/502,120, filed on May 15, 2023.

(51) Int. Cl. G01C 21/34; G08B 21/18

(52) U.S. Cl. CPC G01C 21/3469

(57) ABSTRACT

A planning method for private vehicle carbon footprint verification and emission reduction, wherein the planning method comprises: receiving vehicle information of private vehicles input from an electronic device; receiving a departure information and a destination information input by a user through the electronic device; planning multiple route options including a carbon reduction route option according to the vehicle information, the departure information and the destination information; receiving the user's input for the carbon reduction route option; after comparing the actual carbon emissions with the minimum carbon emissions of the carbon reduction route options, determining whether to issue bonus messages to the user according to the actual carbon reduction achieved through carbon footprint verification and emission reduction calculation method.

### BACKGROUND OF THE INVENTION

### 1. Field of the Invention

The present invention mainly relates to the technical field of vehicle driving, and in particular to a planning method and system for private vehicle carbon footprint verification and emission reduction.

### 2. Description of the Prior Art

Nowadays, vehicle navigation systems typically utilize the Global Positioning System (GPS) to determine a vehicle's position and direction, and then display the current position and route on the map data via the display screen. GPS technology can perform positioning through satellite signals, and the accuracy of positioning varies according to the strength and number of signals, and usually has higher accuracy in areas with fewer buildings.

In addition to GPS, some vehicle navigation systems may also use other positioning technologies, such as Wi-Fi-based positioning, cellular positioning, and inertial navigation. Moreover, some vehicle navigation systems are equipped with sensors such as on-board cameras and radar, which can improve the accuracy and safety of routes through image recognition and object detection.

In order to provide a better user experience, some navigation systems also have functions such as voice navigation, real-time traffic reports, and offline map downloads.

With the support of emerging technologies such as the Internet of Vehicles and the Internet of Things, future vehicle navigation systems may become more intelligent, such as personalized route planning based on user preferences, traffic, and environmental factors.

There are several problems that need to be improved in current navigation systems:

Real-time update of road traffic conditions: Current navigation systems typically rely on historical data and prediction models to calculate routes, but when traffic conditions change, navigation systems often fail to update in a timely manner, resulting in users not receiving the latest route recommendations.

Positioning accuracy: The accuracy of a navigation system depends on the positioning accuracy of the user, but in environments such as urban high-rise buildings and tall buildings, the positioning accuracy is limited, resulting in reduced accuracy of the navigation system.

Vehicle size limitations: Navigation systems typically only plan routes based on road restrictions and speed, but for special vehicles (such as large vehicles, hazardous material transport vehicles, etc.), navigation systems cannot provide corresponding route recommendations.

Parking navigation: Current navigation systems generally only provide driving navigation functions, and the support for parking navigation functions is not sufficient, which brings certain difficulties to the management and use of urban parking lots.

Air pollution: Current navigation systems only plan routes based on the shortest or fastest route, without considering factors such as air pollution. This means that navigation systems cannot provide more environmentally friendly route recommendations and cannot effectively control vehicle carbon emissions.

Especially in today's world of increasing environmental awareness, countries around the world have been exploring carbon emission issues in recent years. However, a large number of vehicles traveling on convenient transportation and well-developed roads result in considerable carbon emissions. Therefore, calculating the amount of carbon emissions and how to reduce the amount of carbon emissions have become the primary problems that need to be solved.

In addition, with the increase in environmental awareness, all sectors of society are paying more and more attention to the impact of the greenhouse effect, and the carbon dioxide emitted during vehicle operation is the main factor that causes the greenhouse effect. Therefore, how to reduce the carbon emissions of vehicles during operation through vehicle route planning has become an urgent issue that needs to be resolved in this field.

### SUMMARY OF THE INVENTION

In order to solve the aforementioned problem of how to reduce carbon emissions during vehicle operation, the present application provides a planning method and system for private vehicle carbon footprint verification and emission reduction.

The planning method for private vehicle carbon footprint verification and emission reduction provided by the present invention comprises:
receiving vehicle information of a private vehicle input from an electronic device having a communication circuit by a vehicle operation data sorting platform and a third-party map data platform, wherein the vehicle information comprises a vehicle size factor, a fuel consumption factor, a brand factor, and a tire pressure factor;
receiving departure information and destination information input by a user through the electronic device by the vehicle operation data sorting platform and the third-party map data platform;
planning multiple route options including a carbon reduction route option by a high-precision map data model, a traffic prediction model, and a multi-objective route planning algorithm according to the vehicle size factor, the fuel consumption factor, the brand factor, the tire pressure factor, the departure information, and the destination information;
receiving the carbon reduction route option input by the user via the electronic device;
collecting a mileage information and a fuel consumption data generated during driving by a sensor built into the private vehicle, the electronic device, or a big data model through a transportation management system, an on-board automatic diagnosis system, or an over-the-air download technology;
calculating an actual carbon emission by the transportation management system, the on-board automatic diagnosis system, or the over-the-air download technology according to the mileage information and the fuel consumption data;
comparing the actual carbon emission with a minimum carbon emission of the carbon reduction route option, and determining whether to issue a bonus message to the user according to an actual carbon reduction amount generated by a carbon footprint verification and emission reduction calculation method.

In a planning system for private vehicle carbon footprint verification and emission reduction provided by the present invention, the planning system comprises:
a client management module for controlling a vehicle operation data sorting platform and a third-party map data platform to receive vehicle information of a private vehicle input from an electronic device having a communication circuit, wherein the vehicle information comprises a vehicle size factor, a fuel consumption factor, a brand factor, and a tire pressure factor;
a journey management module for controlling the vehicle operation data sorting platform and the third-party map data platform to receive departure information and destination information input by a user through the electronic device;
an order management module for controlling a high-precision map data model, a traffic prediction model, and a multi-objective route planning algorithm to plan multiple route options including a carbon reduction route option by the order management module according to the vehicle size factor, the fuel consumption factor, the brand factor, the tire pressure factor, the departure information, and the destination information;
a vehicle owner management module for controlling the electronic device to receive the carbon reduction route option input by the user;
a vehicle management module for controlling a sensor built into the private vehicle, the electronic device, or a big data model through a transportation management system, an on-board automatic diagnosis system, or an over-the-air download technology to collect a mileage information and a fuel consumption data generated during driving;
a route learning unit for controlling the transportation management system, the on-board automatic diagnosis system, or the over-the-air download technology to calculate an actual carbon emission according to the mileage information and the fuel consumption data;
a bonus feedback module for comparing the actual carbon emission with a minimum carbon emission of the carbon reduction route option, and determining whether to issue a bonus message to the user according to an actual carbon reduction amount generated by a carbon footprint verification and emission reduction calculation method.

The planning method proposed by the present invention collects driving process data during the driving process, then analyzes these data to calculate the actual carbon emission. Then, after comparing the actual carbon emission with the minimum carbon emission of the carbon reduction route option, it generates an actual carbon reduction amount based on the carbon footprint verification and emission reduction calculation method to determine whether to issue a bonus message to the user. By providing this route to the user (e.g., driver) to guide their driving, it can help reduce the vehicle's carbon emissions, thereby reducing the impact of pollution on the environment, and also contributing to the carbon market.

To make the above objectives, features, and advantages of the present invention more apparent and easier to understand, the following describes specific embodiments with reference to the accompanying drawings.

### BRIEF DESCRIPTION OF THE DRAWINGS

FIG. 1 is a flow chart of the route planning method utilizing data calculation and analysis provided by the first embodiment of the present invention;

FIG. 2 is a block diagram of the route planning system utilizing data calculation and analysis provided by the first embodiment of the present invention;

FIG. 3 is a block diagram of the route planning system utilizing data calculation and analysis provided by the second embodiment of the present invention;

FIG. 4 is a flow chart of the route planning method utilizing data calculation and analysis provided by the second embodiment of the present invention;

FIG. 5 is a flow chart of the route planning method utilizing data calculation and analysis provided by the third embodiment of the present invention;

FIG. 6 is a flow chart of the route planning method utilizing data calculation and analysis provided by the fourth embodiment of the present invention.

### DETAILED DESCRIPTION OF THE PREFERRED EMBODIMENTS

In the following, various embodiments of the present invention will be described in detail with reference to the drawings. However, the concept of the present invention may be embodied in many different forms and should not be interpreted as limited to the exemplary embodiments set forth herein. Also, the same reference numerals in the drawings may be used to represent similar components.

The planning system of the present invention mainly comprises:
a user management module: includes functions such as registration, login, personal information editing, and payment method setting;
a vehicle owner management module: includes functions such as registration, login, vehicle registration, and vehicle information editing, and the vehicle owner inputs vehicle information such as brand, model, weight, and tire pressure through the vehicle owner management module;
a journey management module: includes functions such as user ride-hailing, vehicle owner order acceptance, journey arrangement, route navigation, and payment;
a route planning module: the route planning module mainly plans routes based on the pickup and drop-off locations input by the user and provides at least three options, including the shortest time route, the lowest price route, and the lowest carbon emission route;
a scoring management module: includes functions such as user rating for vehicle owners, vehicle owner rating for users, rating calculation, and other related functions;
an order management module: includes functions such as order query, order modification, order cancellation, and other related functions;
a payment management module: includes functions such as user payment, vehicle owner receipt of payment, payment history query, and other related functions;
a notification management module: includes functions such as journey notification, payment notification, rating notification, and other related functions;
an administrator backend module: includes functions such as user management, vehicle owner management, journey management, order management, and rating management;
a bonus (reward) feedback module: when a user chooses the route with the minimum carbon emission and completes the journey, the system calculates the actual carbon emission reduction during the journey using a specific conversion formula and provides bonus feedback to the user, and the form of bonus feedback is not limited and can be points, cash, vouchers, etc.

In the route planning process, many factors affect the estimated planning, such as energy type, vehicle brand, vehicle model, vehicle environmental standard, vehicle weight, temperature, driving mileage, tire pressure, recommended engine speed, wind direction, wind resistance coefficient, and road gradient.

Specifically, the collection of wind direction information data can include but is not limited to the following methods:
collecting wind direction information from meteorological stations or the Internet: wind direction information provided by meteorological stations or the Internet can be obtained through network APIs (application programming interfaces) or webpage downloads;
integrating wind direction information into the route planning system: the collected wind direction information is integrated into the route planning system through the interface designed by the system;
confirming the parameters used in route calculation: confirm whether the route planning system requires additional parameters such as resistance coefficients;
calculating routes: calculate the optimal route using comprehensive wind direction information and through the route planning module that affects carbon emissions.

The resistance coefficient is one of the specific parameters of a vehicle, which requires knowledge of the vehicle's shape and coefficient. It can be obtained from the vehicle manual provided by the manufacturer (entered by the user in the present planning system). In order to incorporate the (wind) resistance coefficient data into the route planning system, the collected resistance coefficient data needs to be stored in a database, and algorithms are used to calculate the resistance coefficient on the route.

In the route planning process, the planning system selects the optimal route based on information such as the distance between the starting point and the endpoint, traffic flow, speed limit, and gradient. In this process, the planning system can calculate the resistance coefficient on the route by searching for the resistance coefficient data in the database.

When the resistance coefficient on the route is calculated, the system can incorporate it into the vehicle carbon emission calculation to provide more accurate route planning results.

Specifically, road gradient data can be collected through various means such as inertial sensors installed on vehicles, GPS, and electronic maps. Inertial sensors (i.e., at least one sensor of the vehicle, which can include speed sensors, fuel consumption sensors, wind speed sensors, and rainfall sensors) detect the acceleration and direction changes of the vehicle to infer the road gradient, while GPS can detect changes in the vehicle's position and infer the road gradient based on elevation differences between different locations.

The collected road gradient data can be processed through algorithms in the route planning module. Dynamic planning or other optimization algorithms can be used to find the route with the least carbon emissions. When calculating or planning routes, the planning system can consider the impact of road gradient and adjust parameters such as speed and acceleration to reduce vehicle carbon emissions.

The present invention can obtain vehicle data through various methods including but not limited to TMS (Transportation Management System), OBD2 (on-board diagnostic second generation), OTA (over-the-air), etc.

The planning method proposed in the present application includes a navigation function, allowing private car use. After inputting the starting point and destination, the route planning module calculates multiple route options based on vehicle information, real-time traffic conditions, and third-party map data, including the option with the lowest carbon emissions.

TMS (Transportation Management System) is a software system used to manage logistics and transportation operations, with the main purpose of optimizing and controlling the entire logistics and transportation process. GPS (Global Positioning System) is a global positioning system that can accurately locate and track the position of moving objects and provide real-time map data and navigation route assistance.

TMS can integrate GPS technology to achieve optimized and efficient logistics management by tracking logistics and transportation activities in real-time. TMS can use the location data provided by GPS to achieve the following functions:
real-time monitoring and tracking of vehicle locations and driving routes;
optimizing transportation routes to save time, costs, and reduce carbon emissions;
comprehensively considering vehicle and cargo status to maximize transportation efficiency;
providing real-time updates of routes and traffic conditions to help drivers avoid congested roads and shorten driving distances.
OBD2 is an abbreviation for on-board diagnostic second generation, which is a standard for vehicle emission control systems. OBD2 is a diagnostic system that monitors the operation of a vehicle's emission system and Engine Control Module (ECM) and issues warnings when problems are detected.

The OBD2 system is usually connected to the vehicle's ECM through a plug of a connector called an OBD2 connector. The OBD2 connector can collect diagnostic data from the vehicle, such as speed, engine RPM, oil pressure, air-fuel ratio, coolant temperature, etc. These data can be displayed through diagnostic tools or the vehicle's dashboard, allowing vehicle owners and mechanical engineers to better understand the vehicle's operating conditions.

The OBD2 system can also detect and record fault codes to alert vehicle owners and mechanical engineers of potential vehicle problems. These fault codes can be read and decoded using diagnostic tools, enabling mechanical engineers to quickly locate and repair problems, thereby improving vehicle reliability and performance.

Specifically, the purpose of collecting carbon emission data can be achieved by using an OBD2 device connected to the OBD2 socket. The OBD2 device can read parameters such as engine RPM and vehicle speed, and then estimate carbon emissions through some calculation methods (e.g., fuel consumption rate algorithms based on vehicle speed and engine RPM). The collected data can be transmitted to the backend database for storage and analysis via wireless methods such as Bluetooth or Wi-Fi.

In addition, OTA (Over-The-Air) is a technology that wirelessly upgrades software and updates configurations for private vehicle equipment. In the automotive industry, OTA technology is mainly used for private vehicle software upgrades, function additions, security vulnerability fixes, parameter settings, etc. Using OTA technology can reduce the number of times vehicles need to return to repair shops, improve user experience, and provide better product support and management capabilities for automobile manufacturers.

OTA technology can be applied to the collection and update of vehicle carbon emission data. Specifically, through the connection of the OBD2 interface of a private vehicle to the Internet, carbon emission data of the vehicle can be transmitted to the backend system for collection and analysis. The carbon emission data of the vehicle can be directly read through the diagnostic function of the OBD2 interface and then uploaded to the backend system via OTA technology. In the backend system, statistical analysis can be performed on the carbon emission data of the private vehicle, and further optimization of route planning, driving behavior, and other aspects can be carried out to reduce vehicle carbon emissions. In addition, through OTA technology, vehicle software upgrades and configuration updates can also be performed to achieve more accurate carbon emission data collection and better carbon emission control.

The specific steps of route learning for private cars (which can be referred to as private vehicles) in the present application are as follows:
data collection: the system captures vehicle driving data through methods such as TMS, OBD2, and OTA, including information such as start and end times, locations, distances, speeds, traffic conditions, vehicle types, and carbon emissions;
data pre-processing: pre-process the collected data, such as noise removal, logging missing data, and data format conversion;
feature extraction: extract meaningful features from the preprocessed data, such as the distance between the starting point and destination, traffic congestion, and time;
model training: machine learning models, such as neural networks and decision trees, will be trained using the extracted features, and the goal of training is to enable the model to predict which route between a given starting point and destination is the fastest, cheapest, and most environmentally friendly;
route planning: when a user inputs the starting point and destination, the route planning module predicts the optimal route based on the trained model, and at the same time, it dynamically adjusts based on real-time traffic conditions and the driver's location of the private vehicle to ensure the realization of the optimal route;
feedback and optimization: after the user selects a route, the route planning module collects journey data as feedback for the model, and this data is used to improve the model, making the next step of route planning more accurate.

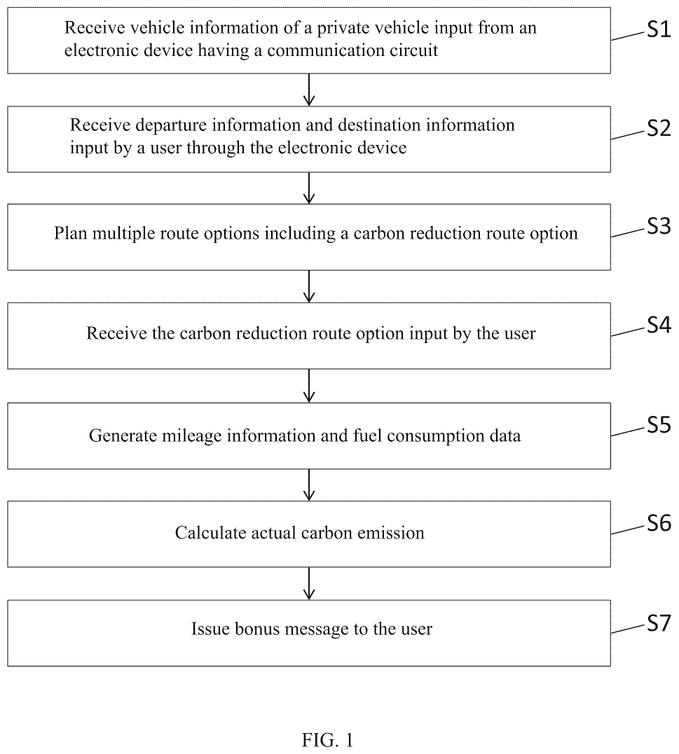

Referring to FIG. 1, FIG. 1 is a flow chart of the route planning method utilizing data calculation and analysis provided by the first embodiment of the present invention. At step S1, a vehicle operation data sorting platform and a third-party map data platform receive vehicle information of a private vehicle input from an electronic device having a communication circuit, wherein the vehicle information includes but is not limited to a vehicle size factor, a fuel consumption factor, a brand factor, and a tire pressure factor. At step S2, the vehicle operation data sorting platform and the third-party map data platform receive departure information and destination information input by a user through the electronic device. For example, the vehicle operation data sorting platform (e.g., bb truck platform) and the third-party map data platform receive vehicle information of a private vehicle (e.g., vehicle size factor, fuel consumption factor, brand factor, vehicle manufacturer factor, vehicle model factor, vehicle environmental standard factor, vehicle weight factor, predetermined driving route factor, temperature factor, vehicle mileage factor, vehicle tire pressure factor, vehicle engine factor, etc.), starting point information of the driving route, and endpoint information of the driving route input from an electronic device (e.g., smartphone, laptop, or tablet).

In step S3, a high-precision map data model, a traffic prediction model, and a multi-objective route planning algorithm plan multiple route options including a carbon reduction route option according to the vehicle size factor, the fuel consumption factor, the brand factor, the tire pressure factor, the departure information, and the destination information. For example, high-precision map data can provide more accurate road condition information, such as the number of lanes, traffic signs, speed limits, etc., to plan more precise predetermined driving routes. In other words, a high-precision map data provider's API (Application Programming Interface) is used to obtain high-precision map data.

In the route planning process, the planning system selects the optimal route based on information such as the distance between the starting point and the endpoint, traffic flow, speed limit, and gradient. In this process, the system can calculate the resistance coefficient on the route by searching for resistance coefficient data in the database.

The resistance coefficient is a specific parameter of a vehicle, which requires knowledge of the vehicle's shape and coefficient. It can be obtained from the vehicle manual provided by the manufacturer (the user can input it into the planning system of the present application). In order to incorporate the resistance coefficient data into the route planning system, the collected resistance coefficient data needs to be stored in the database, and algorithms are used to calculate the resistance coefficient on the route.

When the resistance coefficient on the route is calculated, the planning system of the present application can incorporate it into the vehicle carbon emission calculation to provide more accurate route planning results.

Specifically, road gradient data can be collected through various means such as inertial sensors installed on the vehicle (e.g., speed sensors, fuel consumption sensors, wind speed sensors, rainfall sensors, OBD (on-board diagnostic)-II (second generation) interfaces, OBD-II readers, etc.), GPS, maps, etc. Inertial sensors can detect the acceleration and direction changes of the vehicle to infer the road gradient, while GPS can detect changes in the vehicle's position and infer the road gradient based on elevation differences between different locations.

The collected road gradient data can be processed through algorithms in the route planning module of the planning system. Dynamic planning or other optimization algorithms can be used to find the route with the least carbon emissions. When calculating routes, the system can consider the impact of road gradient and adjust parameters such as speed and acceleration to reduce vehicle carbon emissions.

For example, the Google Maps Platform built into the electronic device provides high-precision map data API. The traffic prediction model built into the electronic device can predict future traffic conditions and plan routes to avoid traffic congestion. In other words, using the traffic prediction model API to obtain traffic prediction information. For example, the Google Maps Platform provides a traffic prediction model API. The multi-objective route planning algorithms (e.g., A* search algorithm, Dijkstra's algorithm, Bellman-Ford algorithm, Floyd-Warshall algorithm, etc.) built into the electronic device or downloaded via the Internet can simultaneously consider multiple factors, such as journey distance, journey time, carbon emissions, etc., to plan routes that balance multiple objectives. For example, before driving the vehicle, the user inputs vehicle-related information and the starting and ending points of the planned route through the input unit (e.g., touch screen or keyboard) of the electronic device. By using at least one of the high-precision map data model, traffic prediction model, and multi-objective route planning algorithm (representing one of the three models and algorithms, or two of them, or a comprehensive application of the three models and algorithms together), the output unit (e.g., display screen) of the electronic device provides a general route option, a carbon reduction route option, and a fast route option, effectively increasing user experience and giving drivers multiple driving route choices.

At step S4, the electronic device receives the carbon reduction route option input by the user. For example, when the user selects the carbon reduction route option, a low-carbon driving route is planned using the carbon footprint verification and emission reduction calculation method, avoiding congested road sections and considering factors such as weather and vehicle-related information, effectively improving the accuracy of carbon emission planning. It is worth noting that the planning method of the present application also utilizes the route learning unit built into the electronic device. After each journey ends, the route planning module calculates the actual carbon emissions of the journey and compares them with the estimated carbon emissions at the beginning. When it is found that the actual carbon emissions are less than the estimated carbon emissions, the route learning unit analyzes what factors caused this difference. For example, it may be because the actual route driven by the vehicle owner is different from the expected route, or it may be because the vehicle owner drove faster, resulting in a shorter journey time than expected. The route learning unit continuously learns from instances where the actual carbon emissions of each journey are less than the estimated carbon emissions, so that the next route planning can be more precise, achieving greater carbon emission reductions and effectively improving environmental protection.

In an embodiment, at step S5, a sensor built into the private vehicle, an electronic device, or a big data model collects a mileage information and a fuel consumption data generated during driving through a transportation management system, an on-board automatic diagnosis system, or an over-the-air download technology. Wind speed information generated during driving is collected by a sensor built into the private vehicle, an electronic device, or a big data model through a transportation management system, an on-board automatic diagnosis system, or an over-the-air download technology. The wind direction information is information obtained through the vehicle size factor, the fuel consumption factor, the brand factor, the tire pressure factor combined with updated information from a meteorological station and/or network predicted meteorological information. For example, in the route planning process, there are many factors that affect the estimated planning, such as energy type, vehicle brand, model, vehicle environmental standard, vehicle weight, temperature, driving mileage, tire pressure, recommended engine speed, wind direction, resistance coefficient, and road gradient.

Specifically, the collection of wind direction information data (which can be referred to as wind direction information) can include but is not limited to the following methods:
collecting wind direction information from meteorological stations or the Internet: wind direction information provided by meteorological stations or the Internet can be obtained through methods such as network APIs (application programming interfaces), network capture, or downloading;
integrating wind direction information into the route planning system: integrating the collected wind direction information into the route planning system through the API interface designed by the system;
confirming the parameters used in route calculation: confirming whether the route planning system requires additional parameters such as resistance coefficients;
calculating routes: calculating the optimal route using comprehensive wind direction information through the route planning module that affects carbon emissions.

For example, at least one sensor of the private vehicle, an electronic device, or a big data model utilizes the vehicle carbon emission data collection algorithm to calculate the driving process data generated by the private vehicle during the operation on a predetermined driving route. For example, the at least one sensor of the private vehicle includes speed sensors, fuel consumption sensors, wind speed sensors, rainfall sensors, OBD (on-board diagnostic)-II (second generation) interfaces, OBD-II readers, etc., which can be used to estimate carbon emissions. When the speed sensor detects a higher instantaneous speed or instantaneous acceleration of the vehicle, the carbon emissions increase accordingly. When the fuel consumption sensor detects an increase in fuel consumption, the carbon emissions also increase accordingly. The wind speed sensor can be used in conjunction with the speed sensor. When the wind speed encountered by the vehicle is higher, it means that the instantaneous speed or instantaneous acceleration is higher, and the carbon emissions also increase accordingly (the resistance coefficient on the route can be calculated by searching for resistance coefficient data in the database). When the rainfall sensor detects an increase in rainfall, the rainwater will carry away more carbon compounds and other exhaust gases emitted by the private vehicle, and the carbon emissions will also decrease accordingly.

Therefore, the driving process data generated by multiple sensors of the private vehicle during the operation on the predetermined driving route includes carbon emission data. The vehicle carbon emission data collection algorithm for calculating the carbon emission data of a specific vehicle can take into account the energy type of the private vehicle (e.g., pure electric vehicles, fuel vehicles, hybrid vehicles, etc.), as well as the vehicle manufacturer factor, vehicle model (e.g., private small passenger cars, SUVs, trucks, etc.) factor, vehicle environmental standard factor, vehicle weight factor, predetermined driving route (e.g., congested road sections, highway sections, mountain road sections, etc.) factor, temperature factor, vehicle mileage factor, vehicle tire pressure factor, vehicle engine factor, etc.

In addition, the OBD-II interface of the private vehicle can be used to obtain data from the vehicle's built-in sensors, and the OBD-II reader can be used to obtain data such as vehicle speed and fuel consumption. For example, the electronic device can use the GPS (Global Positioning System) and other sensors (e.g., gyroscope, when it detects that the vehicle is tilted upward, it means that it is on a mountain road climbing section of the predetermined driving route) of a smartphone to collect data during driving. The built-in or downloaded Google Maps application of a smartphone can be used to collect data during driving. In other words, a smartphone can collect data during driving through GPS and other sensors, and a smartphone can be used to estimate carbon emissions. Additionally, big data models can be used to estimate carbon emissions from driving process data. Traffic flow data, weather data, etc. can be used to estimate carbon emissions. In other words, big data platforms can be used to collect and analyze data such as traffic flow data and weather data. For example, the Google Cloud Platform built into the electronic device can be used to collect and analyze big data to obtain data such as traffic flow data and weather data.

Furthermore, the driving process data, mileage information, and fuel consumption data of a specific vehicle operating on the predetermined driving route can be calculated using the vehicle carbon emission data collection algorithm by at least one sensor of the vehicle, an electronic device, or a big data model through a transportation management system (TMS), an on-board automatic diagnosis system second generation (OBD-II), or an over-the-air download technology (OTA), effectively increasing the accuracy of the vehicle carbon emission data collection algorithm to calculate or predict more accurate driving process data including carbon emissions.

In an embodiment, the carbon footprint verification and emission reduction calculation method plans a predetermined driving route used by general users, such as the one provided by Google Maps. It is worth noting that when the user selects the fast route option, the carbon footprint verification and emission reduction calculation method plans a fast driving route, avoiding congested road sections. The carbon footprint verification and emission reduction calculation method does not calculate variable factors such as uphill and downhill slopes of the route, or does not calculate factors that may affect carbon emissions, such as vehicle type, mileage, and fuel consumption. The display screen of the electronic device then generates a carbon emission payment message.

When the carbon footprint verification and emission reduction calculation method calculates variable factors such as uphill and downhill slopes of the route, or calculates factors that may affect carbon emissions, such as vehicle type, mileage, and fuel consumption, the display screen of the electronic device may generate a bonus feedback message due to the reduction of carbon emissions, which can offset the carbon emission payment message. This means that the bonus feedback message obtained by the user within a certain time range (e.g., a week, a month, a quarter, or a year) can be provided by an environmental protection app platform as a refueling or charging (applicable to pure electric vehicles) discount message. This effectively generates a general route option, a carbon reduction route option, and a fast route option through at least one of the high-precision map data model, traffic prediction model, and multi-objective route planning algorithm based on vehicle-related information, starting point information of the driving route, and endpoint information of the driving route, allowing users to obtain refueling or charging discount messages provided by an environmental protection app platform, increasing carbon reduction and environmental protection, and enhancing user experience. For example, when the user selects the route with minimum carbon emissions and completes the journey, the planning system calculates the reward feedback given to the user of the private vehicle based on the actual carbon emission reduction during the journey using a specific conversion formula.

In an embodiment, at step S6, the transportation management system, the on-board automatic diagnosis system, or the over-the-air download technology calculates an actual carbon emission based on the mileage information and the fuel consumption data. At step S7, after comparing the actual carbon emission with a minimum carbon emission of the carbon reduction route option, a decision is made whether to issue a bonus message to the user based on an actual carbon reduction amount generated by a carbon footprint verification and emission reduction calculation method. For example, the transportation management system, the on-board automatic diagnosis system, or the over-the-air download technology calculates a vehicle speed information, a vehicle mileage information, and a driving time information of the user during driving based on the mileage information and the fuel consumption data.

The transportation management system, the on-board automatic diagnosis system, or the over-the-air download technology updates a low-carbon driving route with the minimum carbon emission based on the vehicle speed information, the vehicle mileage information, and the driving time information. For example, according to an update signal, the processor of the electronic device generates real-time updated general route option, carbon reduction route option, and fast route option at a next time point and/or a next location by at least one of the high-precision map data model, the traffic prediction model, and the multi-objective route planning algorithm, allowing the driver to select immediately updated general route option, carbon reduction route option, and fast route option at different time points and locations at any time or location, effectively improving the real-time nature of road condition information updates.

For example, when a similarity between the low-carbon driving route and a predetermined driving route is lower than a preset value, a carbon emission payment message is generated; when the similarity between the low-carbon driving route and the predetermined driving route is higher than a preset value, a notification message is generated. Furthermore, the vehicle operation data sorting platform and/or the third-party map data platform determine the similarity between the low-carbon driving route and the predetermined driving route. When the similarity between the low-carbon driving route and the predetermined driving route is higher than a preset value (e.g., 90%), the actual carbon emission reduction will generate a bonus message to be issued according to the announced price by the vehicle operation data sorting platform or the third-party map data platform, including a point message, a cash message, or a coupon message. When the similarity between the low-carbon driving route and the predetermined driving route is lower than a preset value (e.g., 75%), a carbon emission payment message is generated. The bonus message can offset the carbon emission payment message, representing that the bonus message and the carbon emission payment message are negatively correlated. The obtained bonus message can be provided by an environmental protection app platform combined with the vehicle operation data sorting platform or the third-party map data platform as a refueling or charging discount message, effectively increasing environmental protection while reducing carbon pollution.

As described above, the present application uses private vehicle information as the basis for determining carbon emissions, combines user-input starting points and destinations, utilizes third-party map data to calculate distances and real-time road conditions, and plans routes with minimum carbon emissions. Finally, the actual carbon emissions are calculated using the vehicle carbon emission data collection algorithm to determine the actual carbon emission reduction, and this is used as the basis for calculating the reward feedback provided to the user. The present application involves the method of collecting data during the driving process to achieve route planning with minimum carbon emissions. The planning method includes the following steps: First, collect data during the driving process, including the vehicle's speed, acceleration, fuel consumption, etc. Then, analyze this data to calculate the carbon emissions of each road section. Next, based on the carbon emissions, use the data calculation and analysis method to plan the route with minimum carbon emissions. Finally, provide this route to the driver to guide their driving. This method can help reduce vehicle carbon emissions, thereby reducing the impact on the environment. In addition, the planning method can also provide personalized route planning based on different needs, such as journey time, journey distance, weather changes, etc. Personalized route planning includes general route options, carbon reduction route options, and fast route options.

The present application can focus on the usage scenarios for private cars (e.g., Uber), supplement the “route planning method” and “data collection method during driving”, let the driver decide the route, and the system determines whether to give the driver bonus feedback. It also increases illustrative examples of usage scenarios, such as how different variables affect the route planning method, what different routes are ultimately planned, or how carbon emissions are calculated based on the collected data to confirm whether the low-carbon option is followed to complete the task. In other words, the present application effectively generates carbon reduction route options through at least one of the high-precision map data model, traffic prediction model, and multi-objective route planning algorithm based on vehicle-related information, starting point information of the driving route, and endpoint information of the driving route to confirm whether the user follows the low-carbon option to complete the task, and obtains refueling (applicable to fuel vehicles and hybrid or mixed vehicles) or charging discount messages provided by an environmental protection app platform, increasing the Earth's carbon reduction and reducing environmental pollution, while enhancing user experience.

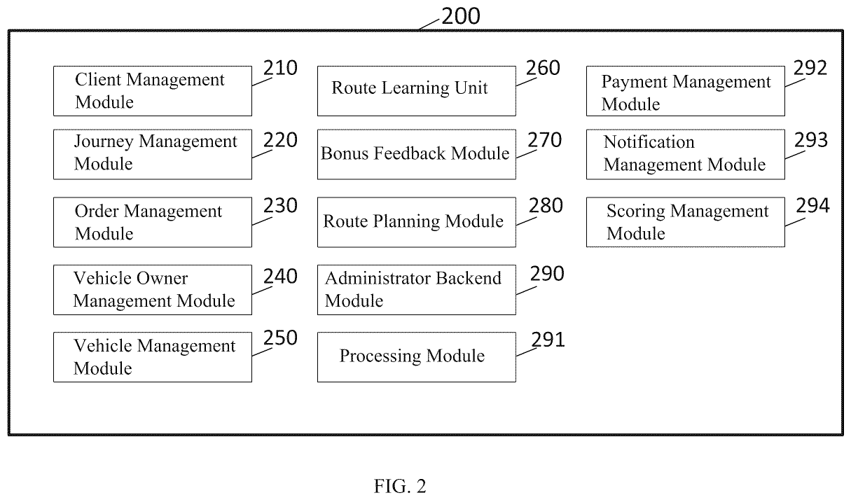

Referring to FIG. 2, FIG. 2 is a block diagram of the route planning system utilizing data calculation and analysis provided by the first embodiment of the present invention. The present invention provides a planning system for private vehicle carbon footprint verification and emission reduction. The planning system 200 comprises:
a client management module 210 for controlling a vehicle operation data sorting platform and a third-party map data platform to receive vehicle information of a private vehicle input from an electronic device having a communication circuit, wherein the vehicle information comprises a vehicle size factor, a fuel consumption factor, a brand factor, and a tire pressure factor;
a journey management module 220 for controlling the vehicle operation data sorting platform and the third-party map data platform to receive departure information and destination information input by a user through the electronic device;
an order management module 230 for controlling a high-precision map data model, a traffic prediction model, and a multi-objective route planning algorithm to plan multiple route options including a carbon reduction route option by the order management module based on the vehicle size factor, the fuel consumption factor, the brand factor, the tire pressure factor, the departure information, and the destination information;
a vehicle owner management module 240 for controlling the electronic device to receive the carbon reduction route option input by the user;
a vehicle management module 250 for controlling a sensor built into the private vehicle, an electronic device, or a big data model through a transportation management system, an on-board automatic diagnosis system, or an over-the-air download technology to collect a mileage information and a fuel consumption data generated during driving;
a route learning unit 260 for controlling the transportation management system, the on-board automatic diagnosis system, or the over-the-air download technology to calculate an actual carbon emission based on the mileage information and the fuel consumption data;
a bonus feedback module 270 for comparing the actual carbon emission with a minimum carbon emission of the carbon reduction route option, and determining whether to issue a bonus message to the user based on an actual carbon reduction amount generated by a carbon footprint verification and emission reduction calculation method.

In an embodiment, the planning system 200 comprises:
a route planning module 280 for controlling the transportation management system, the on-board automatic diagnosis system, or the over-the-air download technology to calculate a vehicle speed information, a vehicle mileage information, and a driving time information of the user during driving based on the mileage information and the fuel consumption data;
an administrator backend management module 290 for updating a low-carbon driving route in the minimum carbon emission based on the vehicle speed information, the vehicle mileage information, and the driving time information.

In an embodiment, the planning system 200 comprises:
a processing module 291 for controlling the sensor built into the private vehicle, the electronic device, or the big data model through the transportation management system, the on-board automatic diagnosis system, or the over-the-air download technology to collect a wind speed information generated during driving.

In an embodiment, the planning system 200 comprises:
a payment management module 292, wherein when a similarity between the low-carbon driving route and a predetermined driving route is lower than a preset value, the payment management module 292 generates a carbon emission payment message;
a notification management module 293, wherein when the similarity between the low-carbon driving route and the predetermined driving route is higher than the preset value, the notification management module 293 generates a notification payment message;
   wherein the wind direction information is information obtained through the vehicle size factor, the fuel consumption factor, the brand factor, the tire pressure factor combined with updated information from a meteorological station and/or network predicted meteorological information.

In an embodiment, the planning system 200 comprises:
a scoring management module 294 for determining the bonus message to be a point message, a cash message, or a coupon message. For the description of the embodiment in FIG. 2, please refer to the content of FIG. 1, which will not be repeated here.

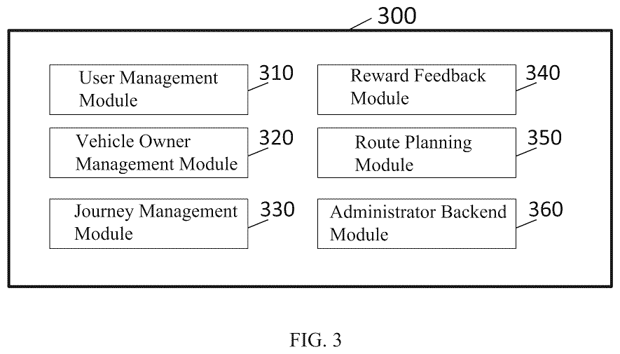

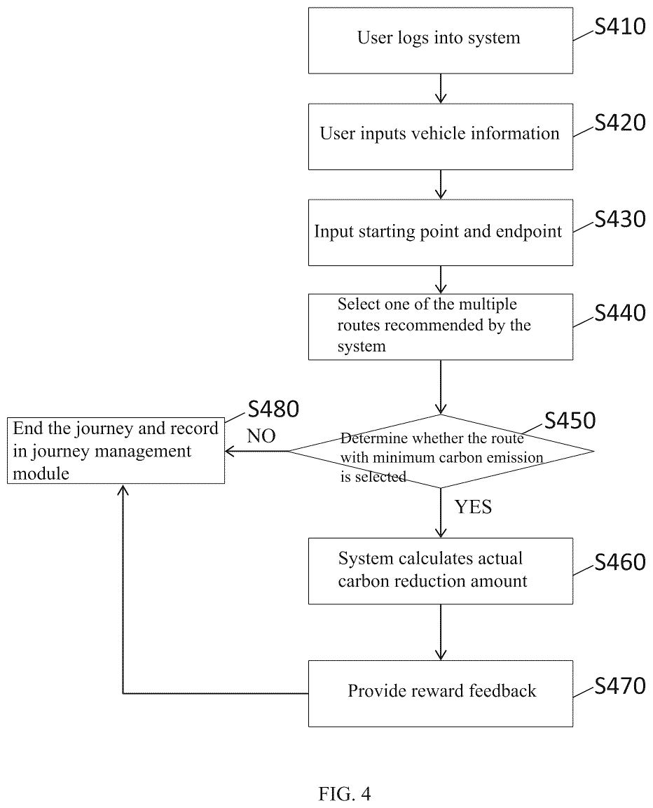

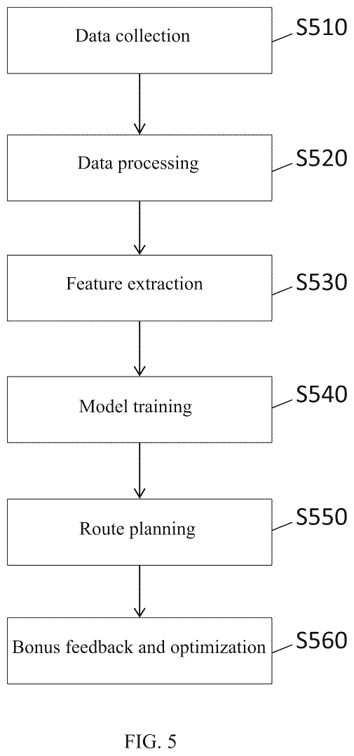

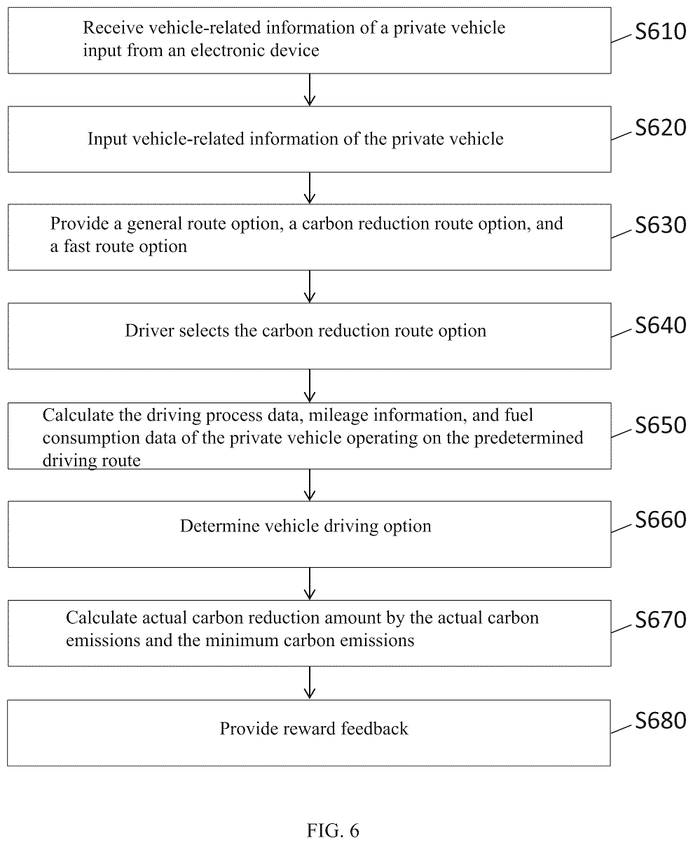

Please also refer to FIGS. 3-6, where FIG. 3 is a block diagram of the route planning system utilizing data calculation and analysis provided by the second embodiment of the present invention. FIG. 4 is a flow chart of the route planning method utilizing data calculation and analysis provided by the second embodiment of the present invention. FIG. 5 is a flow chart of the route planning method utilizing data calculation and analysis provided by the third embodiment of the present invention. FIG. 6 is a flow chart of the route planning method utilizing data calculation and analysis provided by the fourth embodiment of the present invention.

The route planning system 300 in FIG. 3 comprises a user management module 310 (compare with the description of the client management module 210 in FIG. 2), a vehicle owner management module 320 (compare with the description of the vehicle owner management module 240 in FIG. 2), a journey management module 330 (compare with the description of the journey management module 220 in FIG. 2), a reward feedback module 340 (compare with the description of the bonus feedback module 270 in FIG. 2), a route planning module 350 (including a route planning unit (not shown in the figure), compared with the description of the route planning module 280 in FIG. 2), and an administrator backend module 360 (compare with the description of the administrator backend module 292 in FIG. 2).

In FIG. 4, at step S410, the user logs into the system; at step S420, the user inputs vehicle information; at step S430, the starting point and endpoint are input; at step S440, one of the multiple routes recommended by the system is selected; at step S450, it is determined whether the user has selected the route with minimum carbon emission; at step S460, the system calculates the actual carbon reduction amount; at step S470, reward feedback is provided; at step S480, the journey is ended and recorded in the journey management module.

In FIG. 5, at step S510, data is collected; at step S520, data is processed; at step S530, features are extracted; at step S540, model training is performed; at step S550, route planning is done; at step S560, bonus feedback and optimization occur.

In FIG. 6, at step S610, the vehicle operation data sorting platform (e.g., bb truck platform) and/or the third-party map data platform is logged into to receive vehicle-related information of a private vehicle input from an electronic device (e.g., smartphone, laptop, or tablet); at step S620, the vehicle-related information of the private vehicle is input: vehicle manufacturer factor, vehicle model factor, vehicle environmental standard factor, vehicle weight factor, predetermined driving route factor, temperature factor, vehicle mileage factor, vehicle tire pressure factor, vehicle engine factor, starting point information of the driving route and endpoint information of the driving route, wind direction, wind resistance factor, hill slope; at step S630, a general route option, a carbon reduction route option, and a fast route option are provided; at step S640, the driver selects the carbon reduction route option; at step S650, the driving process data, mileage information, and fuel consumption data of the private vehicle operating on the predetermined driving route are calculated through a transportation management system (TMS), an on-board automatic diagnosis system second generation (OBD-II), or an over-the-air download technology (OTA) using the vehicle carbon emission data collection algorithm; at step S660, the vehicle driving option is determined after the vehicle journey ends; at step S670, the actual carbon reduction amount is calculated by the actual carbon emissions and the minimum carbon emissions; and at step S680, a reward feedback is provided. For the description of the embodiments in FIGS. 3-6, please refer to the content of FIGS. 1-2, which will not be repeated here.

As described above, the present invention discloses a planning method and system that includes a route learning unit. After each journey ends, the route planning module calculates the actual carbon emissions of the journey and compares them with the estimated carbon emissions at the beginning. When it is found that the actual carbon emissions are less than the estimated carbon emissions, the route learning unit can analyze what factors caused this difference. For example, it may be because the actual route driven by the vehicle owner is different from the expected route, or it may be because the vehicle owner drove faster, resulting in a shorter journey time than expected. The route learning unit continuously learns from each instance where the actual carbon emissions are less than the estimated carbon emissions, so that the next route planning can be more precise, achieving greater carbon emission reductions, which helps private vehicles save energy and reduce carbon.

The present invention utilizes the technology of the route planning module to provide the system as a navigation system application for general private vehicle users. After logging into the system, users can input relevant information about their private vehicles, such as vehicle size, fuel consumption, brand, tire pressure, etc., as the basis for estimating carbon emissions. Then, the users input the starting point and destination, and the route planning module plans routes, providing multiple route options, including at least the option with the lowest carbon emissions. Finally, when the users select the route with minimum carbon emissions and completes the journey, the bonus feedback module calculates the actual carbon emission reduction and sends a bonus message to the users.

The present invention mainly uses the vehicle information provided by the vehicle owner as the basis for determining carbon emissions. Combined with the starting point and destination input by the user, the present invention utilizes third-party map data to calculate distances and real-time traffic conditions and plans the route with minimum carbon emissions. Finally, the present invention uses the vehicle carbon emission data collection algorithm to calculate the actual carbon emissions, determines the actual carbon reduction amount, and the bonus feedback provided to the user is calculated based on the actual carbon reduction amount.

Although the present invention has been disclosed in the above embodiments, they are not intended to limit the present invention. Those skilled in the art to which the present invention pertains may make some modifications and refinements without departing from the spirit and scope of the present invention. Therefore, the protection scope of the present invention should be defined by the appended claims.

What is claimed is:

1. A planning method for private vehicle carbon footprint verification and emission reduction, wherein the planning method comprises:
receiving vehicle information of a private vehicle input from an electronic device having a communication circuit by a vehicle operation data sorting platform and a third-party map data platform, wherein the vehicle information comprises a vehicle size factor, a fuel consumption factor, a brand factor, and a tire pressure factor;
receiving departure information and destination information, input by a user through the electronic device, by the vehicle operation data sorting platform and the third-party map data platform;
planning multiple route options including a carbon reduction route option by a high-precision map data model, a traffic prediction model, and a multi-objective route planning algorithm according to the vehicle size factor, the fuel consumption factor, the brand factor, the tire pressure factor, the departure information, and the destination information;
receiving the carbon reduction route option input by the user via the electronic device;
collecting a mileage information and a fuel consumption data generated during driving by a sensor built into the private vehicle, the electronic device, or a big data model through a transportation management system, an on-board automatic diagnosis system, or an over-the-air download technology;
calculating an actual carbon emission by the transportation management system, the on-board automatic diagnosis system, or the over-the-air download technology according to the mileage information and the fuel consumption data;
comparing the actual carbon emission with a minimum carbon emission of the carbon reduction route option, and determining whether to issue a bonus message to the user according to an actual carbon reduction amount generated by a carbon footprint verification and emission reduction calculation method.

2. The planning method of claim 1, wherein the planning method comprises:
calculating a vehicle speed information, a vehicle mileage information, and a driving time information of the user during driving by the transportation management system, the on-board automatic diagnosis system, or the over-the-air download technology according to the mileage information and the fuel consumption data;
updating a low-carbon driving route in the minimum carbon emission by an administrator backend management module according to the vehicle speed information, the vehicle mileage information, and the driving time information.

3. The planning method of claim 2, wherein the planning method comprises:
collecting a wind speed information generated during driving by the sensor built into the private vehicle, the electronic device, or the big data model through the transportation management system, the on-board automatic diagnosis system, or the over-the-air download technology.

4. The planning method of claim 3, wherein the planning method comprises:
the wind direction information is information obtained through the vehicle size factor, the fuel consumption factor, the brand factor, the tire pressure factor combined with updated information from a meteorological station and/or network predicted meteorological information;
generating a carbon emission payment message when a similarity between the low-carbon driving route and a predetermined driving route is lower than a preset value;
generating a notification message when the similarity between the low-carbon driving route and the predetermined driving route is higher than the preset value.

5. The planning method of claim 1, wherein the planning method comprises the bonus message including a point message, a cash message, or a coupon message.

6. A planning system for private vehicle carbon footprint verification and emission reduction, wherein the planning system comprises:
a client management module for controlling a vehicle operation data sorting platform and a third-party map data platform to receive vehicle information of a private vehicle input from an electronic device having a communication circuit, wherein the vehicle information comprises a vehicle size factor, a fuel consumption factor, a brand factor, and a tire pressure factor;
a journey management module for controlling the vehicle operation data sorting platform and the third-party map data platform to receive departure information and destination information input by a user through the electronic device;
an order management module for controlling a high-precision map data model, a traffic prediction model, and a multi-objective route planning algorithm to plan multiple route options including a carbon reduction route option by the order management module according to the vehicle size factor, the fuel consumption factor, the brand factor, the tire pressure factor, the departure information, and the destination information;
a vehicle owner management module for controlling the electronic device to receive the carbon reduction route option input by the user;
a vehicle management module for controlling a sensor built into the private vehicle, the electronic device, or a big data model through a transportation management system, an on-board automatic diagnosis system, or an over-the-air download technology to collect a mileage information and a fuel consumption data generated during driving;
a route learning unit for controlling the transportation management system, the on-board automatic diagnosis system, or the over-the-air download technology to calculate an actual carbon emission according to the mileage information and the fuel consumption data;
a bonus feedback module for comparing the actual carbon emission with a minimum carbon emission of the carbon reduction route option, and determining whether to issue a bonus message to the user according to an actual carbon reduction amount generated by a carbon footprint verification and emission reduction calculation method.

7. The planning system of claim 6, wherein the planning system comprises:
a route planning module for controlling the transportation management system, the on-board automatic diagnosis system, or the over-the-air download technology to calculate a vehicle speed information, a vehicle mileage information, and a driving time information of the user during driving according to the mileage information and the fuel consumption data;
an administrator backend management module for updating a low-carbon driving route in the minimum carbon emission according to the vehicle speed information, the vehicle mileage information, and the driving time information.

8. The planning system of claim 7, wherein the planning system comprises:
a processing module for controlling the sensor built into the private vehicle, the electronic device, or the big data model through the transportation management system, the on-board automatic diagnosis system, or the over-the-air download technology to collect a wind speed information generated during driving.

9. The planning system of claim 8, wherein the planning system comprises:
a payment management module, wherein when a similarity between the low-carbon driving route and a predetermined driving route is lower than a preset value, the payment management module generates a carbon emission payment message;
a notification management module, wherein when the similarity between the low-carbon driving route and the predetermined driving route is higher than the preset value, the notification management module generates a notification message;
wherein the wind direction information is information obtained through the vehicle size factor, the fuel consumption factor, the brand factor, the tire pressure factor combined with updated information from a meteorological station and/or network predicted meteorological information.

10. The planning system of claim 6, wherein the planning system comprises:
a scoring management module for determining the bonus message to be a point message, a cash message, or a coupon message.
